(19) United States
(12) Patent Application Publication
(10) Pub. No.: US 2003/0225911 A1
(43) Pub. Date: Dec. 4, 2003

(54) Method and apparatus for communicating data between IPv4 and IPv6

(75) Inventors: Jae-Hwang Lee, Seoul (KR); Young-Keun Kim, Incheon Metropolitan-City (KR); Hak-Goo Lee, Suwon-si (KR); Sun-Woo Kim, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/361,678

(22) Filed: Feb. 11, 2003

(30) Foreign Application Priority Data
May 29, 2002 (KR) 2002-29954

(51) Int. Cl. G06F 15/16

(52) U.S. Cl. 709/245; 709/249

(57) ABSTRACT

An Internet Protocol version 4 (IPv4)-Internet Protocol version 6 (IPv6) communication method and apparatus for allowing an IPv6 home network to communicate with an IPv4 host are provided. In the IPv4-IPv6 communication method, upon receiving a web address from an IPv6 device of the IPv6 home network, an IPv4 address corresponding to the web address is inquired from a domain name system (DNS). Upon receiving the inquired IPv4 address, the IPv4 address is mapped to an IPv6 address. The mapped IPv4/IPv6 addresses are stored, and a connection to the IPv4 host is set. Data of a web page corresponding to the web address is received from the connected IPv4 host. The received data of the web page is transmitted to the IPv6 device by referring to the mapped IPv4/IPv6 addresses.

### CROSS-REFERENCE TO RELATED APPLICATIONS

This application claims the priority of Korean Patent Application No. 2002-29954, filed May 29, 2002, which is incorporated herein in its entirety by reference.

### BACKGROUND OF THE INVENTION

1. Field of the Invention

The present invention relates to an Internet Protocol version 4 (IPv4)-Internet Protocol version 6 (IPv6) communication system, and more particularly, to a method and apparatus for allowing IPv6 devices in an IPv6 home network to communicate with an IPv4 host.

2. Description of the Related Art

IPv6 Internet addresses have a size of 128 bits to extend addressing capability. In addition, IPv6 can process multimedia data in real time using a flow labeling function. IPv6 also has an enhanced security capability to support authentication and data confidentiality.

However, current Internet networks usually employ an IPv4 format, so devices allocated IPv6 addresses in a home network cannot use most of the Internet employing the IPv4 format. Therefore, network systems for allowing the current IPv6 networks to communicate with the IPv4 protocol have been developed.

FIG. 1 is a diagram of a conventional network system for IPv4-IPv6 communication. Referring to FIG. 1, a dual stack transition mechanism (DSTM) host 130 is a host having an IPv4/IPv6 dual stack. A dynamic host configuration protocol version 6 (DHCPv6) server 140 allocates global IPv4 addresses and tunnel end point (TEP) addresses. A router 160 relays connection between the IPv4 host 180 and the DSTM host 130. When the DSTM host 130 accesses first and second domain name systems (DNSs) 150 and 170 using a domain name, the first and second DNSs 150 and 170 convert the domain name into an IPv4 address.

In operation, the DSTM host 130 in an IPv6 network 110 inquires for an IPv4 address corresponding to the domain name from the first and second DNSs 150 and 170 to acquire the address of an IPv4 host 180. Next, the DSTM host 130 needs an IPv4 address, so it is allocated an IPv4 address and a TEP address through the DHCPv6 server 140. Thereafter, the DSTM host 130 transmits an IPv6 packet including an IPv4 packet to the router 160 through a dynamic tunneling interface (DTI) 190. Subsequently, the router 160 transmits the IPv6 packet to a destination, i.e., the IPv4 host 180 in an IPv4 network. Here, the router 160 stores the IPv6 address and IPv4 address of the DSTM host 130.

However, the conventional network system shown in FIG. 1 has a very complex DSTM and must include elements, i.e., DNS, DHCPv6, DTI, and router, which are not standardized. In particular, the conventional network system shown in FIG. 1 needs DNSs, i.e., the first and second DNSs 150 and 170, in order to check both IPv6 address and IPv4 address. In addition, since the DHCPv6 server 140 must always have a global IPv4 address, the conventional network system shown in FIG. 1 cannot fundamentally overcome a shortage of addresses.

### SUMMARY OF THE INVENTION

The present invention provides an Internet Protocol version 4 (IPv4)-Internet Protocol version 6 (IPv6) communication method for allowing devices in an IPv6 home network to communicate with an IPv4 host in an IPv4 network by installing a dual stack proxy server having both an IPv4 address and an IPv6 address between the IPv6 home network and the IPv4 network.

The present invention also provides an IPv4-IPv6 communication apparatus using the above IPv4-IPv6 communication method.

According to an aspect of the present invention, there is provided an IPv4-IPv6 communication method for allowing IPv6 devices of an IPv6 home network to communicate with an IPv4 host. The IPv4-IPv6 communication method includes upon receiving a web address from an IPv6 device of the IPv6 home network, inquiring for an IPv4 address corresponding to the web address from a domain name system (DNS); upon receiving the inquired IPv4 address, mapping the IPv4 address to an IPv6 address, storing the mapped IPv4/IPv6 addresses, and setting a connection to the IPv4 host; receiving data of a web page corresponding to the web address from the connected IPv4 host; and transmitting the received data of the web page to the IPv6 device by referring to the mapped IPv4/IPv6 addresses.

According to another aspect of the present invention, there is provided an IPv4-IPv6 communication apparatus for allowing IPv6 devices of an IPv6 home network to communicate with an IPv4 host. The IPv4-IPv6 communication apparatus includes a cache section storing received data of a web page; a table section mapping an IPv4 address to an IPv6 address and storing the mapped IPv4/IPv6 addresses; and a protocol controller section, which inquires for an IPv4 address corresponding to a web address received from an IPv6 device of the IPv6 home network from a DNS, maps the inquired IPv4 address to an IPv6 address to connect with the IPv4 host, receives data of a web page corresponding to the web address from the IPv4 host, stores the data in the cache section, and transmits the data of the web page stored in the cache section to the IPv6 device by referring to the mapped IPv4/IPv6 addresses.

### BRIEF DESCRIPTION OF THE DRAWINGS

The above features and advantages of the present invention will become more apparent by describing in detail preferred embodiments thereof with reference to the attached drawings in which:

FIG. 1 is a diagram of a conventional network system for Internet Protocol version 4 (IPv4)-Internet Protocol version 6 (IPv6) communication;

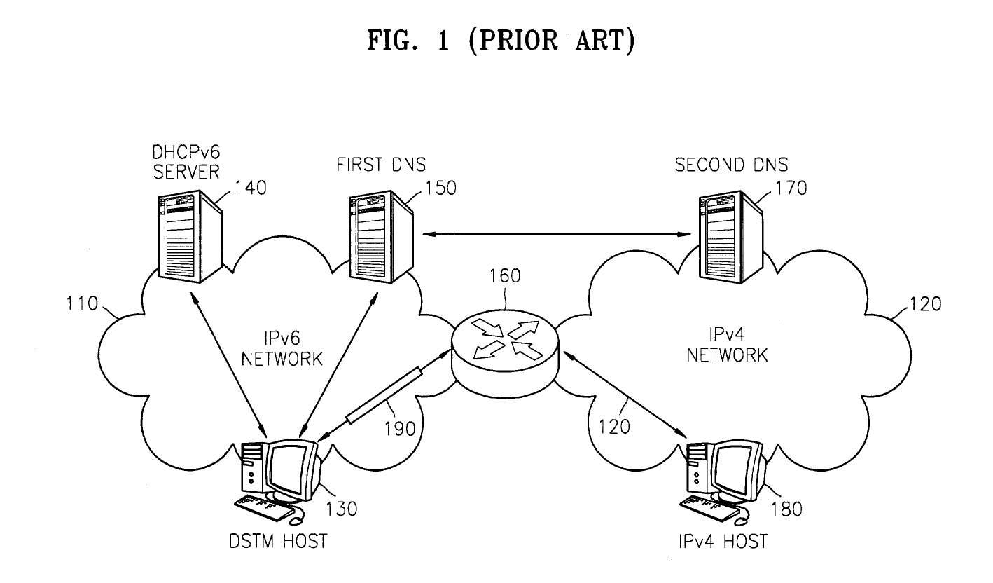

FIG. 2 is a diagram of a network system for IPv4-IPv6 communication according to an embodiment of the present invention;

FIG. 3 is a detailed diagram of a dual stack proxy server (DSPS) shown in FIG. 2; and

FIG. 4 is a flowchart of an IPv4-IPv6 communication method according to an embodiment of the present invention.

### DETAILED DESCRIPTION OF THE INVENTION

Hereinafter, preferred embodiments of the present invention will be described in detail with reference to the attached drawings.

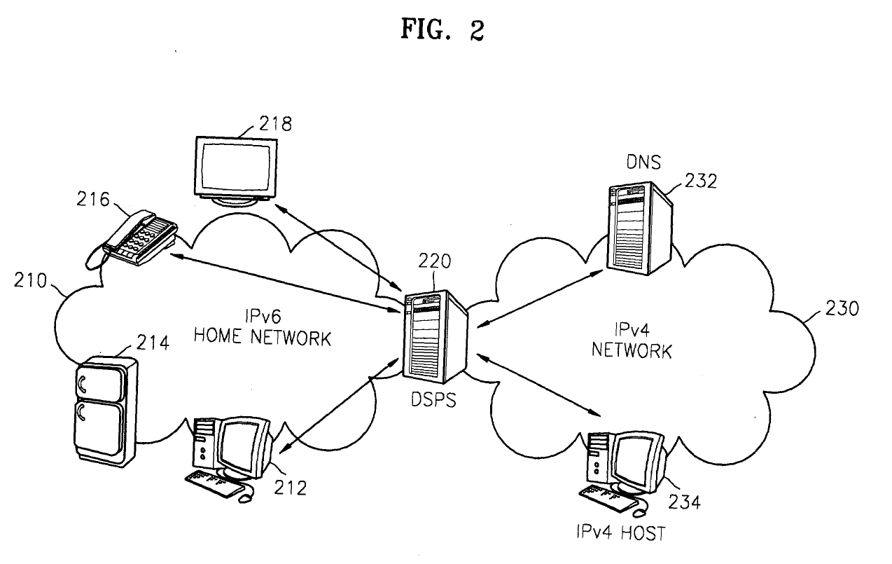

FIG. 2 is a diagram of a network system for Internet Protocol version 4 (IPv4)-Internet Protocol version 6 (IPv6) communication according to an embodiment of the present invention. The network system shown in FIG. 2 includes an IPv6 home network 210 including IPv6 devices 212, 214, 216, and 218 and an IPv4 network 230 including a domain name system (DNS) 232 and an IPv4 host 234. In addition, the network system includes a dual stack proxy server 220, which relays communication between the IPv6 devices 212, 214, 216, and 218 of the IPv6 home network 210 and the IPv4 host 234 of the IPv4 network 230.

Referring to FIG. 2, the IPv6 devices 212, 214, 216, and 218 of the IPv6 home network 210 must use IPv6 applications. The DNS 232 of the IPv4 network 230 converts a domain name requested by the DSPS 220 into an IPv4 address. The DSPS 220 inquires for an IPv4 address, which corresponds to a uniform resource locator (URL) received from an IPv6 devices 212, 214, 216, or 218 of the IPv6 home network 210, from the DNS 232; maps the inquired IPv4 address to an IPv6 address; connects with the IPv4 host 234; receives data of a web page at the URL from the IPv4 host 234; and transmits the web page data to the IPv6 device 212, 214, 216, or 218.

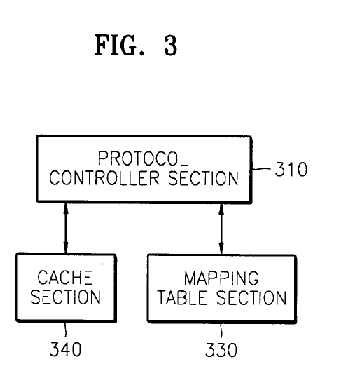

FIG. 3 is a detailed diagram of the DSPS 220. Referring to FIG. 3, a cache section 340 stores data of web pages received from the IPv4 host 234. The mapping table section 330 maps an IPv4 address to an IPv6 address and stores the mapped IPv4/IPv6 addresses. A protocol controller section 310 inquires IPv4 addresses corresponding to URLs received from the IPv6 devices 212, 214, 216, and 218 of the home network 210 from the DNS 232, maps the inquired IPv4 addresses to IPv6 addresses, and stores the result of mapping. In addition, the protocol controller section 310 receives data of web pages at the URLs from the IPv4 host 234, stores the data in the cache section 340, and transmits the data stored in the cache section 340 to the relevant IPv6 devices 212, 214, 216, and 218 referring to the mapped IPv4/IPv6 addresses stored in the mapping table section 330.

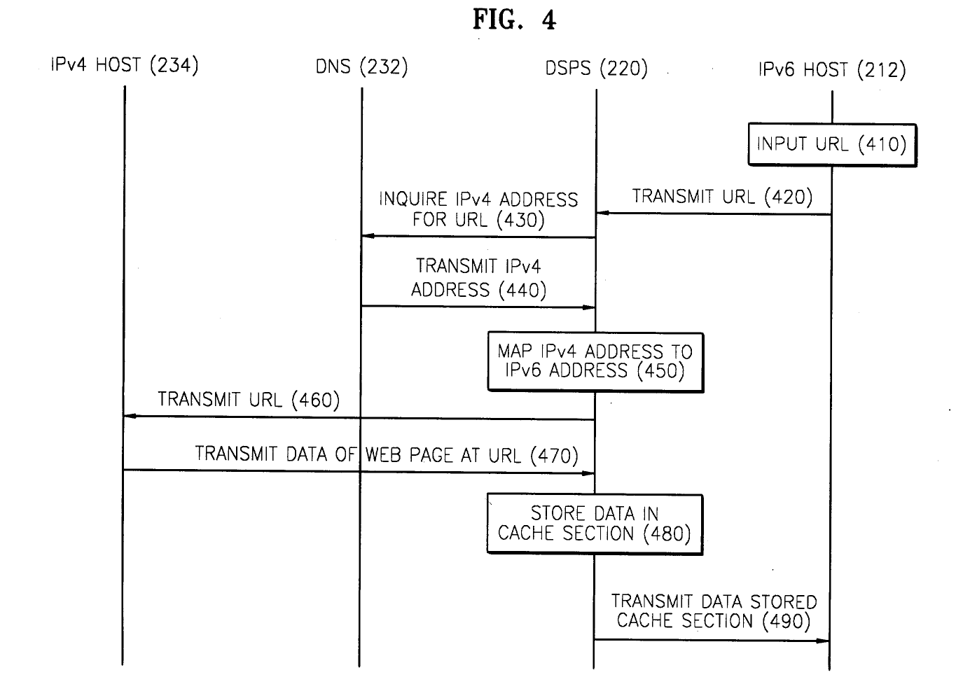

FIG. 4 is a flowchart of an IPv4-IPv6 communication method according to an embodiment of the present invention. Here, it is assumed that the IPv6 host 212 among the IPv6 devices 212, 214, 216, and 218 of the IPv6 home network 210 intends to acquire a web page of the IPv4 host 234 of the IPv4 network 230.

The IPv6 host 212 tries to connect with the IPv4 host 234 in operation 410. For example, the IPv6 host 212 inputs a URL to be accessed through a web browser. Next, the IPv6 host 212 transmits a URL to the DSPS 220 in operation 420.

Next, the DSPS 220 inquires for an IPv4 address corresponding to the URL from the DNS 232 in operation 430. Then, the DNS 232 transmits the inquired IPv4 address to the DSPS 220 in operation 440. For example, the DNS 232 informs the DSPS 220 of the IPv4 address 211.115.109.7 corresponding to the URL www.yahoo.com.

Next, the DSPS 220 maps the IPv4 address received from the DNS 232 to a corresponding IPv6 address and stores the mapped IPv4/IPv6 addresses in the mapping table section 330 in operation 450. Here, the connection between the DSPS 220 and the IPv4 host 234 is set.

Next, the DSPS 220 transmits the URL to the IPv4 host 234 in operation 460. For example, the DSPS 220 transmits a packet including information on its own IPv4 address corresponding to a source and the IPv4 address of the IPv4 host 234 corresponding to a destination to the IPv4 host 234.

Next, the IPv4 host 234 transmits the data of a web page corresponding to the URL to the DSPS 220 in operation 470. Then, the DSPS 220 stores the data of the web page received from the IPv4 host 234 in the cache section 340 in operation 480. Next, the DSPS 220 transmits the data stored in the cache section 340 to the IPv6 host 212 of the IPv6 home network 210 referring to the mapped IPv4/IPv6 addresses stored in the mapping table section 330 in operation 490.

Consequently, by installing the DSPS 220, which stores both an IPv4 address and an IPv6 address between the IPv6 home network 210 and the IPv4 network 230, each of the devices 212, 214, 216, and 218 of the IPv6 home network 210 can communicate with the IPv4 host 234 of the IPv4 network 230.

The present invention can be realized as a code which is recorded on a computer readable recording medium and can be read by a computer. The computer readable recording medium may be any type on which data which can be read by a computer system can be recorded, for example, a ROM, a RAM, a CD-ROM, a magnetic tape, a hard disc, a floppy disc, a flash memory, or an optical data storage device. The present invention can also be realized as carrier waves (for example, transmitted through Internet). Alternatively, computer readable recording media are distributed among computer systems connected through a network so that the present invention can be realized as a code which is stored in the recording media and can be read and executed in the computers.

As described above, the present invention provides a DSPS having both an IPv4 address and an IPv6 address between an IPv6 home network and an IPv4 network so that each device of the IPv6 home network can communicate with a host of the IPv4 network. In addition, since the devices of the IPv6 home network use IPv6 addresses, a shortage of IPv4 addresses can be overcome. Moreover, IPv4 host content that is frequently accessed is stored in the DSPS, so the traffic between the IPv4 host and the DSPS can be reduced.

The present invention is not restricted to the above-described embodiments, and it will be apparent that various changes can be made by those skilled in the art without departing from the spirit of the invention.

What is claimed is:

1. An Internet Protocol version 4 (IPv4)-Internet Protocol version 6 (IPv6) communication method for allowing an IPv6 device with an IPv6 address of an IPv6 home network to communicate with an IPv4 host with an IPv4 address, the IPv4-IPv6 communication method comprising:
upon receiving a web address from the IPv6 device, inquiring for the IPv4 address corresponding to the web address from a domain name system (DNS);
upon receiving the inquired IPv4 address, mapping the IPv4 address to the IPv6 address, storing the mapped IPv4/IPv6 addresses, and setting a connection to the IPv4 host;
receiving data of a web page corresponding to the web address from the connected IPv4 host; and
transmitting the received data of the web page to the IPv6 device referring to the mapped IPv4/IPv6 addresses.

2. The IPv4-IPv6 communication method of claim 1, wherein when a domain name is used when inquiring for the IPv4 address, the DNS converts the domain name into the IPv4 address.

3. The IPv4-IPv6 communication method of claim 1, wherein the received data of the web page is stored in a cache.

4. The IPv4-IPv6 communication method of claim 1, wherein the setting the connection to the IPv4 host comprises:
transmitting the web address to the IPv4 host upon receiving the IPv4 address from the DNS; and
receiving data of the web address from the IPv4 host.

5. An Internet Protocol version 4 (IPv4)-Internet Protocol version 6 (IPv6) communication apparatus for allowing an IPv6 device with an IPv6 address of an IPv6 home network to communicate with an IPv4 host with an IPv4 address, the IPv4-IPv6 communication apparatus comprising:
a cache section storing received data of a web page;
a table section mapping the IPv4 address to the IPv6 address and storing the mapped IPv4/IPv6 addresses; and
a protocol controller section, which inquires for the IPv4 address corresponding to a web address received from the IPv6 device from a domain name system (DNS), maps the inquired IPv4 address to the IPv6 address to connect with the IPv4 host, receives data of a web page corresponding to the web address from the IPv4 host, stores the data in the cache section, and transmits the data of the web page stored in the cache section to the IPv6 device by referring to the mapped IPv4/IPv6 addresses.

6. The IPv4-IPv6 communication apparatus of claim 5, wherein the protocol controller section has a dual stack structure.

7. A computer-readable recording medium for recording a computer program code for enabling a computer to provide a service of allowing an Internet Protocol version 6 (IPv6) device with an IPv6 address of an IPv6 home network to communicate with an Internet Protocol version 4 (IPv4) host with an IPv4 address, the service comprising steps of:
upon receiving a web address from the IPv6 device, inquiring for the IPv4 address corresponding to the web address from a domain name system (DNS);
upon receiving the inquired IPv4 address, mapping the IPv4 address to the IPv6 address, storing the mapped IPv4/IPv6 addresses, and setting a connection to the IPv4 host;
receiving data of a web page corresponding to the web address from the connected IPv4 host; and
transmitting the received data of the web page to the IPv6 device referring to the mapped IPv4/IPv6 addresses.
